(19) United States
(12) Patent Application Publication
(10) Pub. No.: US 2026/0363942 A1
(43) Pub. Date: Nov. 19, 2026

(54) INFLATABLE ROLLER

(71) Applicant: Guangdong Transcontinental Technology Co.,Ltd., Guangzhou (CN)

(72) Inventors: HONG ZHOU, Shenzhen (CN); Zhentong Yang, Hunan Province (CN); Xiaomin Shi, Jieyang (CN); Shaojie Long, Wuchuan City (CN)

(73) Assignee: Guangdong Transcontinental Technology Co.,Ltd., Guangzhou (CN)

(21) Appl. No.: 19/223,331

(22) Filed: May 30, 2025

(30) Foreign Application Priority Data
May 14, 2025 (CN) 202520951281.2

(51) Int. Cl. A61H 15/00

(52) U.S. Cl. CPC A61H 15/00; A61H 2015/0014; A61H 2201/0103; A61H 2201/0161

(57) ABSTRACT

An inflatable roller includes a roller body, which includes a circumferential sidewall, a first end cap and a second end cap connected with two ends of the circumferential sidewall. The circumferential sidewall, the first end cap and the second end cap surround and form an inflatable chamber. The inflatable design allows the roller to be deflated and folded when not in use, making it easy to carry and store, greatly improving the portability and practicality of the product.

### CROSS-REFERENCE TO RELATED APPLICATIONS

The present invention claims priority of Chinese patent application CN2025209512812, filed on May 14, 2025, which is incorporated herein by reference in its entireties.

### TECHNICAL FIELD

The present invention relates to a massage roller, in particular to an inflatable roller.

### BACKGROUND

With the improvement of people's living standards, their demand for health and relief of physical fatigue is increasing. Massage rollers are popular with many people as a convenient and effective tool to assist massage. Traditional massage rollers are usually made of solid or filled materials, with fixed shape and hardness, which are difficult to adjust according to the needs of different users. In addition, the volume of the roller is larger, which is inconvenient to carry and store, limiting its use occasions and convenience.

Therefore, Therefore, the market needs an inflatable massage roller with simple structure, convenient inflation and good sealing performance, which can not only flexibly adjust the massage intensity according to the needs of users, but also can be deflated and stored after use, which is easy to carry and store, to meet the needs of the market and users.

### SUMMARY

The present invention provides an inflatable roller, which can not only flexibly adjust the massage intensity according to the needs of users, but also can be deflated and stored after use, which is easy to carry and store, to meet the needs of the market and users.

The technical solution adopted by the present invention to solve the technical problem is as follows.

An inflatable roller includes a roller body and a first inflatable valve assembly.

The roller body includes a circumferential sidewall, a first end cap and a second end cap connected with two ends of the circumferential sidewall. The circumferential sidewall, the first end cap and the second end cap surround and form an inflatable chamber.

The first inflatable valve assembly is configured on the roller body, and the first inflatable valve assembly is configured to inflate the roller body.

The beneficial effect of the present disclosure is as follows, the present invention provides an inflatable roller, including a roller body having a circumferential sidewall and a first end cap and a second end cap connected with two ends of the circumferential sidewall. The circumferential sidewall, the first end cap and the second end cap surround and form an inflatable chamber. The inflatable design allows the roller to be deflated and folded when not in use, making it easy to carry and store, greatly improving the portability and practicality of the product.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

The present invention is further described below in detail in combination with the accompanying drawings and embodiments.

FIG. 1 is a schematic diagram according to the present invention.

FIG. 2 is a cross-sectional view along a first inflatable valve assembly according to the present invention.

FIG. 3 is a cross-sectional view of one embodiment according to the present invention.

FIG. 4 is an enlarged schematic view of part B of FIG. 3.

FIG. 5 is a schematic diagram of another embodiment according to the present invention.

FIG. 6 is a cross-sectional view along the first inflatable valve assembly and a second inflatable valve assembly of another embodiment according to the present invention.

FIG. 7 is an enlarged schematic view of the first inflatable valve assembly of part A of FIG. 6.

FIG. 8 is a schematic diagram of the first inflatable valve assembly according to the present invention.

FIG. 9 is an exploded view of the first inflatable valve assembly according to the present invention.

FIG. 10 is a schematic diagram of an inner core of the first inflatable valve assembly according to the present invention.

FIG. 11 is a schematic diagram of another embodiment according to the present invention.

FIG. 12 is a cross-sectional view along the first inflatable valve assembly of another embodiment according to the present invention.

FIG. 13 is a cross-sectional view of another embodiment according to the present invention.

FIG. 14 is an enlarged schematic view of part C of FIG. 13.

FIG. 15 is an enlarged schematic view of part D of FIG. 13.

FIG. 16 is an exploded view of another embodiment according to the present invention.

### DESCRIPTION OF EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms "first" and "second" are used for descriptive purposes only and cannot be understood as indicating or implying relative importance or implying the number of indicated technical features. Thus, the features defined as "first" and "second" may explicitly or implicitly include one or more of the said features. In the description of embodiments of the invention, "a plurality of" means two or more, unless otherwise specifically defined.

The terms "top", "bottom", and other indicating directions or positions are based on the directions or positions shown in the attached drawings in order to facilitate the description of the embodiment and simplify the description of the invention, rather than indicating or implying that the device or element referred to must have a specific orientation, be constructed and operated in a specific orientation, it cannot be understood as a limitation of the embodiment of the invention.

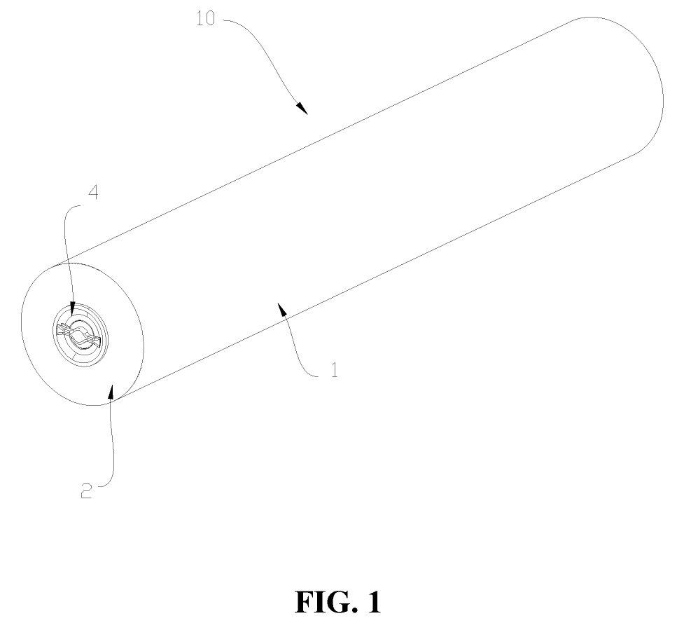

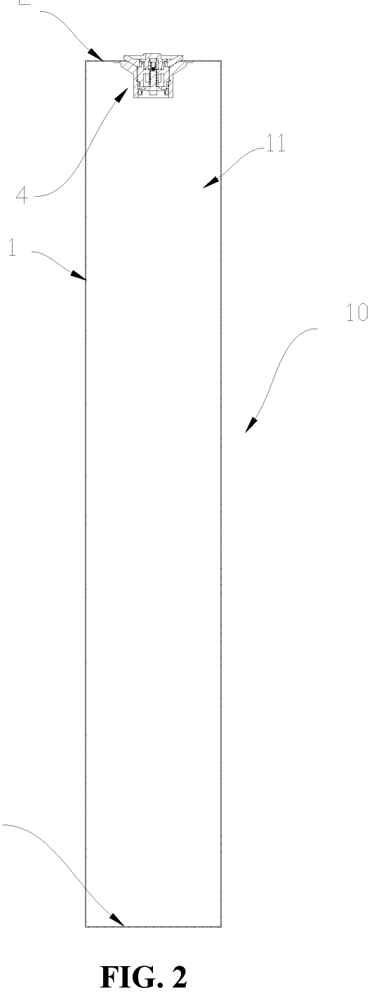

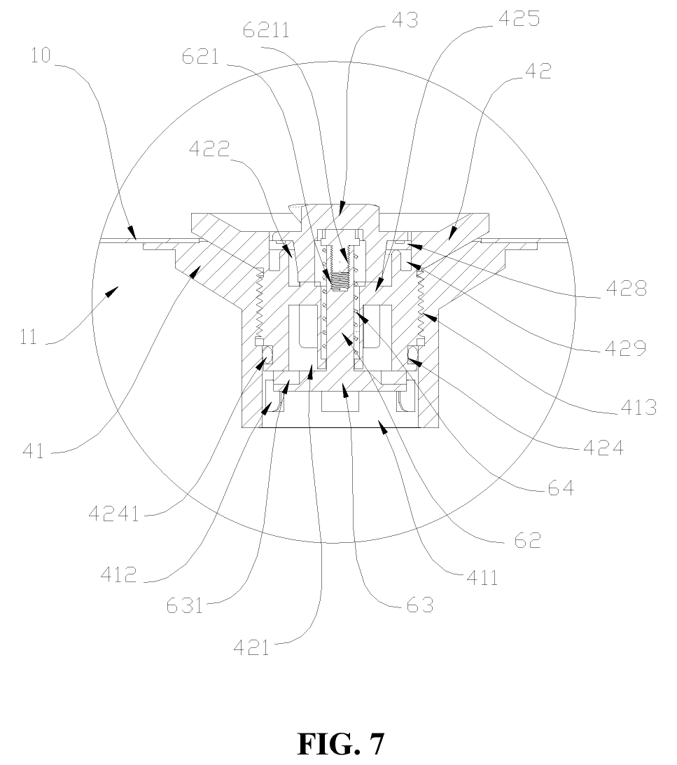

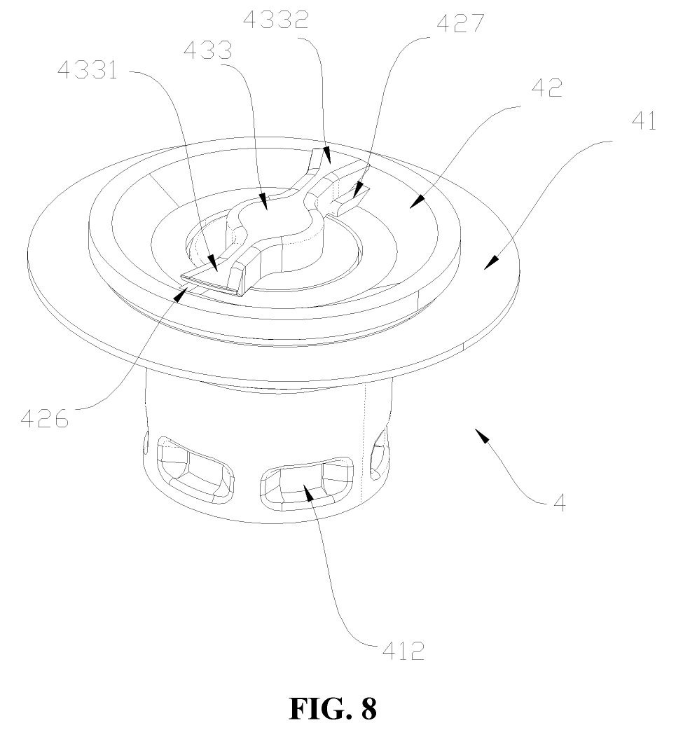

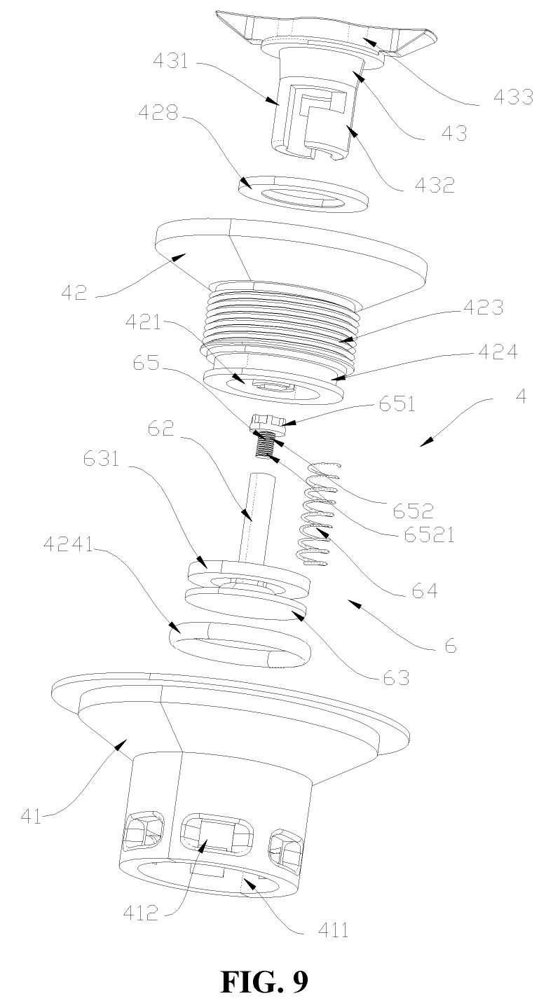

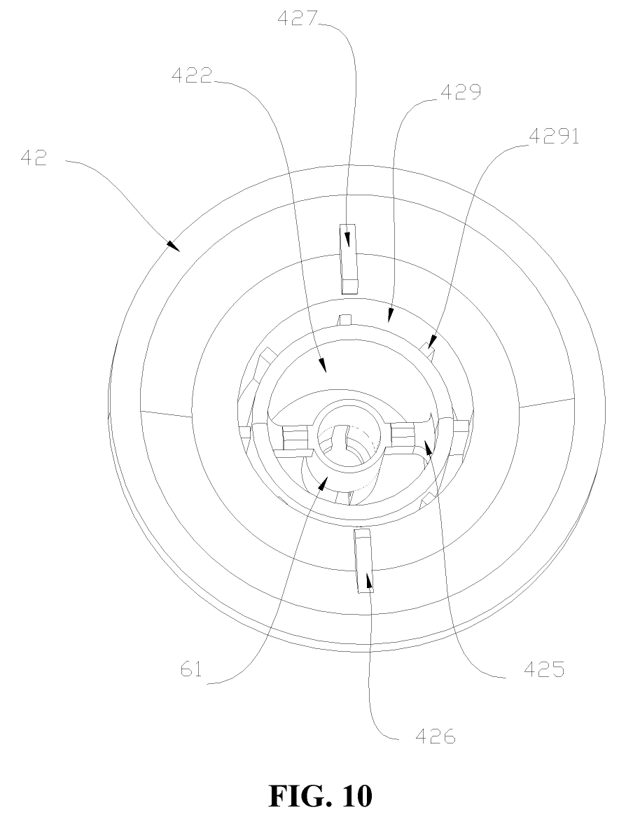

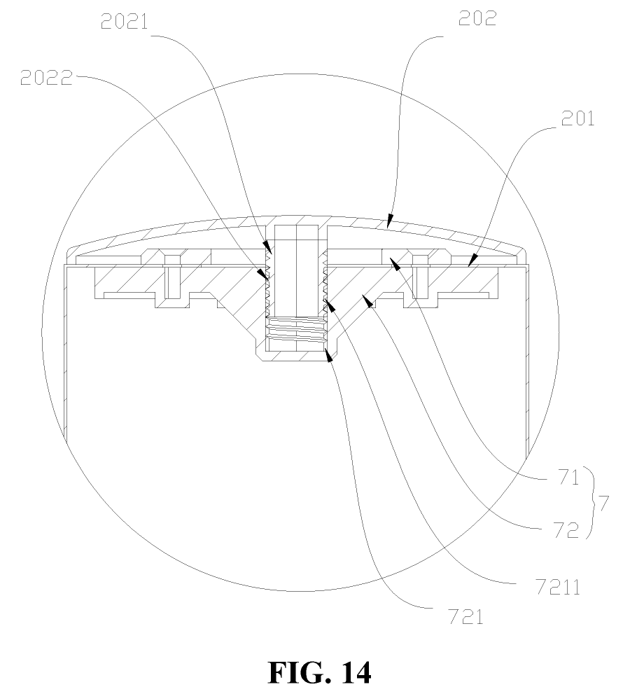

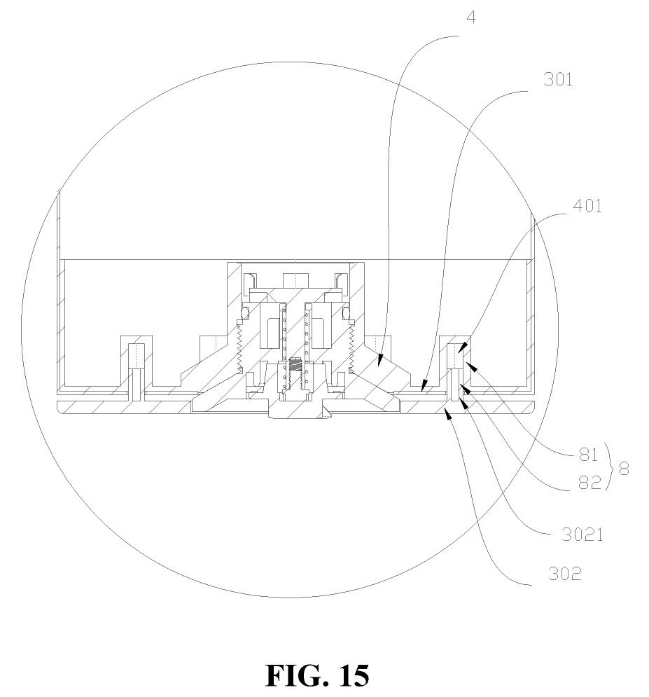

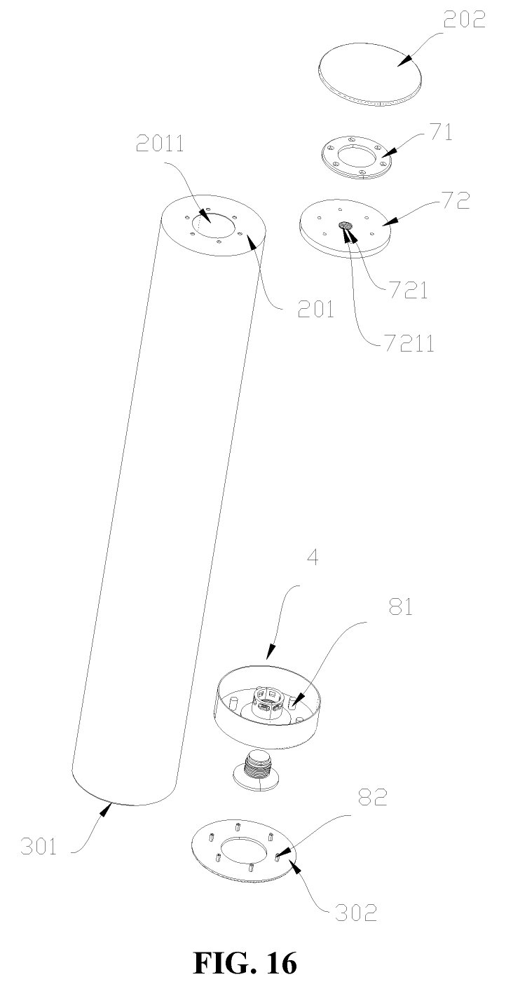

Referring to FIGS. 1-16, an inflatable roller includes a roller body 10 and a first inflatable valve assembly 4.

The roller body 10 includes a circumferential sidewall 1, a first end cap 2 and a second end cap 3 connected with two ends of the circumferential sidewall 1. The circumferential sidewall 1, the first end cap 2 and the second end cap 3 surround and form an inflatable chamber 11.

The first inflatable valve assembly 4 is configured on the roller body 10, and the first inflatable valve assembly 4 is configured to inflate the roller body 10.

With the above structure, the roller body 10 has the inflatable chamber 11 and is configured with the first inflatable valve assembly 4, whereby the hardness and elasticity of the roller can be flexibly adjusted according to user needs, thereby improving the personalization and comfort of the massage experience. At the same time, the inflatable design allows the roller to be deflated and folded when not in use, making it easy to carry and store, greatly improving the portability and practicality of the product.

In this embodiment, the first end cap 2 is connected with the circumferential sidewall 1 by an Voltage heat sealing connection or an adhesive bonding connection or a heat staking connection. The second end cap 3 is connected with the circumferential sidewall 1 by the Voltage heat sealing connection or the adhesive bonding connection or the heat staking connection. With the above structure, by using the Voltage heat sealing connection, the adhesive bonding connection or the heat staking connection, which ensures the sealing and firmness of a connection portion 652, prevents an air leakage of the inflatable chamber 11, and improves the airtightness and safety of the inflatable roller.

In this embodiment, the material of the first end cap 2 and the second end cap 3 is the same as the material of the circumferential sidewall 1. The circumferential sidewall 1 is a TPU circumferential sidewall 1, or a PVC circumferential sidewall 1, or a PP circumferential sidewall 1, or a PE circumferential sidewall 1, or a PE circumferential sidewall 1, or an EVA circumferential sidewall 1, or a PA circumferential sidewall 1, or a PVDF circumferential sidewall 1, or a PET polyester circumferential sidewall 1, or a PTFE circumferential sidewall 1, or an ETFE circumferential sidewall 1, or a PU imitation leather circumferential sidewall 1, or a leather circumferential sidewall 1, or a plastic cement circumferential sidewall 1. With the above structure, the circumferential sidewall is made of a plurality of polymer materials such as TPU, PVC, PP, PE, EVA, PA, PVDF, PET polyester, PTFE, ETFE, PU imitation leather, leather, plastic cement, etc. These materials have excellent flexibility and wear resistance, which can ensure that the roller maintains elasticity and comfort after inflation. The different materials have their own advantages in weather resistance, corrosion resistance, temperature resistance and tensile strength, etc., whereby the roller can flexibly select the most suitable material according to the specific use environment and needs, thereby improving the application scope and service life of the product.

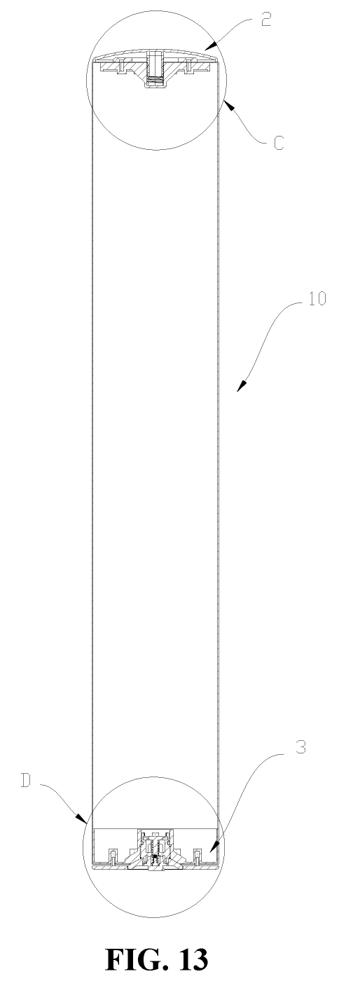

In another embodiment, referring to FIGS. 13-16, the first end cap 2 includes a first inner end cap 201 and a first outer end cap 202. The first inner end cap 201 is connected with the circumferential sidewall 1 by the Voltage heat sealing connection or the adhesive bonding connection or the heat staking connection. The first outer end cap 202 is connected with an outer side of the first inner end cap 201. The first outer end cap 202 is a plastic end cap. The second end cap 3 includes a second inner end cap 301 and a second outer end cap 302. The second inner end cap 301 is connected with the circumferential sidewall 1 by the Voltage heat sealing connection or the adhesive bonding connection or the heat staking connection. The second outer end cap 302 is connected with an outer side of the second inner end cap 301. The second outer end cap 302 is the plastic end cap.

Furthermore, the first outer end cap 202 is connected with the first inner end cap 201 by a first locking assembly 7. The first locking assembly 7 includes a first locking member 71 configured on the outer side of the first inner end cap 201 and a first locking matching member 72 configured on an inner side of the first inner end cap 201 and correspondingly connected with the first locking member 71. The first inner end cap 201 includes a first connection hole 2011. The first locking matching member 72 includes a first connection groovy 721 matching the first connection hole 2011. The first connection groovy 721 is provided with a first internal thread 7211. The first outer end cap 202 is provided with a first connection column 2021 matching the first connection hole 2011. The first connection column 2021 is provided with a first external thread 2022 matching the first internal thread 7211. The second outer end cap 302 is connected with the second inner end cap 301 by a second locking assembly 8. The second locking assembly 8 includes a second locking member 81 configured on the first inflatable valve assembly 4 and located on an inner side of the second inner end cap 301 and a second locking matching member 82 configured on the second outer end cap 302. The second locking member 81 is a second connection groovy 401 configured on the first inflatable valve assembly 4. The second locking matching member 82 is a second connection column 3021 configured on the second end cap 302 and snapped with the second connection groovy 401.

Specifically, the first locking member 71 is a locking ring disposed around the first connection hole 2011. The locking ring is provided with a plurality of locking holes. The first locking matching member 72 is a locking disc. The locking disc is provided with a plurality of locking holes. The first inner end cap 201 is provided with a plurality of locking holes. A screw passes through the locking ring, the first inner end cap 201 and the locking holes on the locking disc in sequence, to fix the first locking assembly 7 on the first inner end cap 201. The second outer end cap 302 includes an avoidance hole, the avoidance hole is configured to avoid the first inflatable valve assembly 4.

With the above structure, by providing the first outer end cap 202 and the second outer end cap 302 made of plastic material, covering the welding mark and bur on both sides of the inflatable roller, making the inflatable roller more beautiful and regular, and improving the purchase attraction.

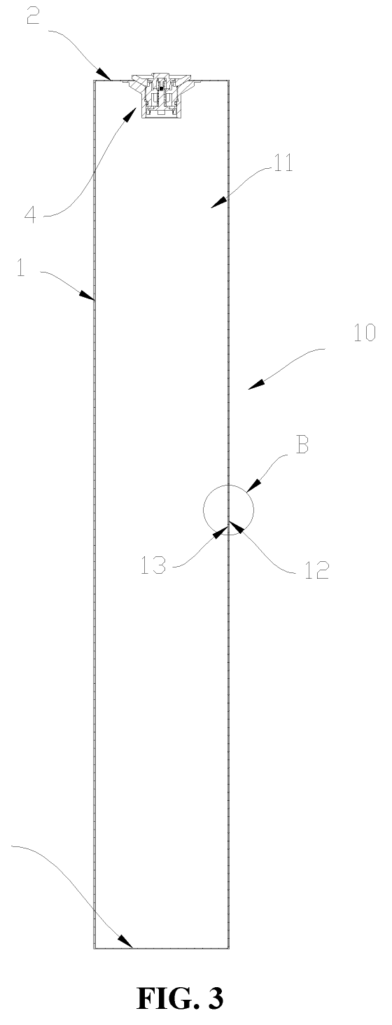

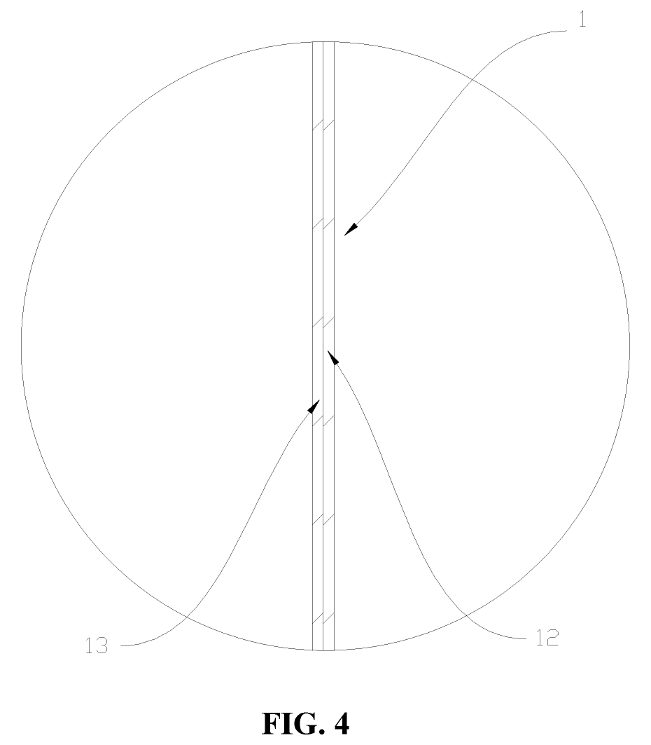

In another embodiment, referring to FIGS. 3-4, the circumferential sidewall 1 is composed of a first sidewall layer 12 and a second sidewall layer 13 in a layered form in an upper and lower direction, the first sidewall layer 12 and the second sidewall layer 13 are sidewall layers made of different materials. In another embodiment, the circumferential sidewall 1 can be composed of more than two layers, such as three layers, four layers, etc. With the above structure, the circumferential sidewall 1 is composed of a first sidewall layer 12 and a second sidewall layer 13 in a layered form in an upper and lower direction, the two layers are made of different materials, through the multilayer composite structure design, the advantages of each material can be effectively combined, to achieve complementary performance, and improve the overall strength, wear resistance and elasticity of the sidewall.

Furthermore, the first sidewall layer 12 is a TPU first sidewall layer 12, or a PVC first sidewall layer 12, or a PP first sidewall layer 12, or a PE first sidewall layer 12, or an EVA first sidewall layer 12, or a PA first sidewall layer 12, or a PVDF first sidewall layer 12, or a PET polyester first sidewall layer 12, or a PTFE first sidewall layer 12, or an ETFE first sidewall layer 12, or a PU imitation leather first sidewall layer 12, or a leather first sidewall layer 12, or plastic cement first sidewall layer 12. The second sidewall layer 13 is a mesh fabric, or an Oxford cloth, or a woven cloth. With the above structure, the first sidewall layer 12 is made of a plurality of polymer materials such as TPU, PVC, PP, PE, EVA, PA, PVDF, PET polyester, PTFE, ETFE, PU imitation leather, leather, plastic cement, etc. These materials have excellent elasticity, abrasion resistance, and airtightness, ensuring the sealing of the inflatable chamber 11 and the flexibility of the roller. The second sidewall layer 13 is a mesh fabric, or an Oxford cloth, or a woven cloth, enhancing the strength and durability of the sidewall, and improving the stability and tear resistance of the overall structure. The composite design of two layers of materials ensures the roller's inflation performance and durability, meeting the diverse demand for product performance in different use environments.

In this embodiment, the first inflatable valve assembly 4 is disposed on the first end cap 2 or the second end cap 3. The first inflatable valve assembly 4 is disposed on the first end cap 2 or the second end cap 3, which is convenient for inflation and deflation operation, and improves the convenience of use. Integrating the inflatable valve on the position of the end cap, which simplifies the structure of the roller body, and facilitates the user to quickly adjust the internal air pressure when needed, thereby realizing personalized adjustments of the hardness and elasticity of the massage roller. This design further contributes to the compactness and beauty of the overall roller structure, to improve the practicality and market competitiveness of the product.

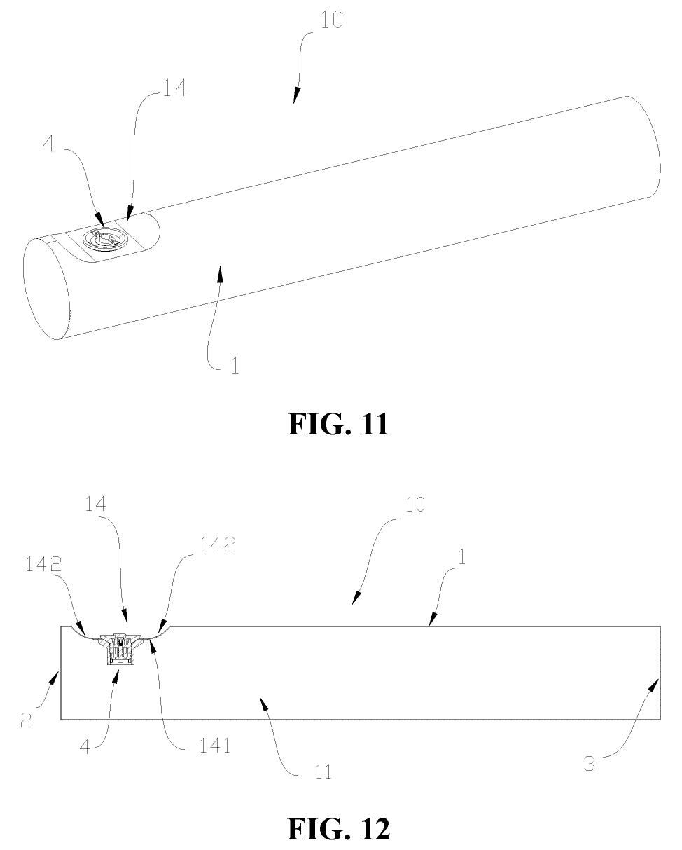

In another embodiment, referring to FIGS. 11-12, the first inflatable valve assembly 4 is disposed on the circumferential sidewall 1. Specifically, the circumferential sidewall 1 is concavely provided with a second mounting groove 14. The second mounting groove 14 includes a flat middle portion 141 and inclined portions 142 on both sides. The first inflatable valve assembly 4 is disposed on the middle portion 141. With the above structure, the first inflatable valve assembly 4 is disposed on the circumferential sidewall 1 and disposed on the middle portion 141 in the second mounting groove 14, ensuring the installation ease of the first inflatable valve assembly 4, improving the personalization of the roller, to facilitate the user to quickly adjust the internal air pressure when needed.

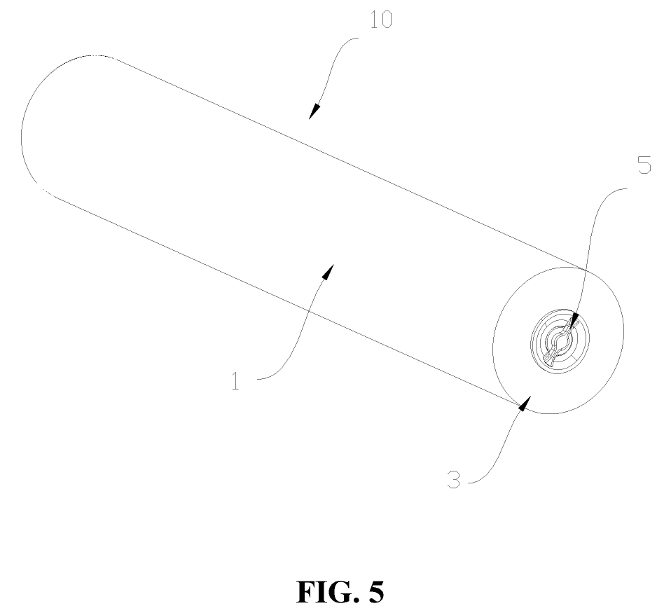

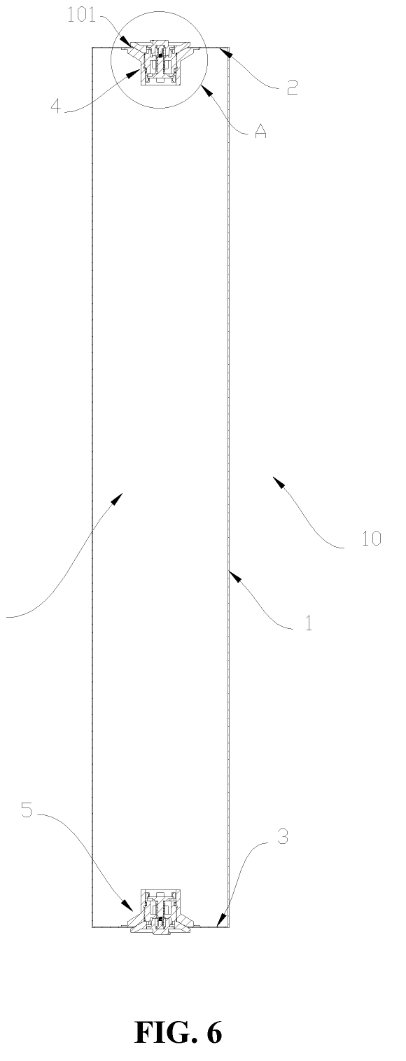

In another embodiment, referring to FIGS. 5-6, further including a second inflatable valve assembly 5, the first inflatable valve assembly 5 is disposed on the first end cap 2. The second inflatable valve assembly 5 is disposed on the second end cap 3. In this embodiment, the second inflatable valve assembly 5 and the first inflation valve assembly 4 have the same structure. With the above structure, by simultaneously configuring the first inflatable valve assembly 4 and the second inflatable valve assembly 5 on the roller body 10, the inflatable chamber 11 of the roller body 10 can be inflated or deflated more efficiently and conveniently, thereby improving the inflation efficiency and convenience of use.

In this embodiment, the roller body 10 includes a mounting port 101 for installing the first inflatable valve assembly 4. The first inflatable valve assembly 4 includes a valve body 41, an inner core 42 and a one-way valve core assembly 6. The valve body 41 is disposed in the inflatable chamber and 11 connected with an inner wall of the roller body 10. The valve body 41 includes a mounting cavity 411 and a first air outlet 412 connected with the mounting cavity 411. The first air outlet 412 is connected with the inflatable chamber 11. The inner core 42 is disposed in the mounting cavity 411 and connected to an inner wall of the valve body 41. A bottom of the inner core 42 includes a second air outlet 421 for connecting with the first air outlet 412. A top of the inner core 42 includes an air inlet 422 connected with the second air outlet 421. The one-way valve core assembly 6 is configured to open or close the second air outlet 421, whereby a gas passes through the air inlet 422, the second air outlet 421, the first air outlet 412 and the inflatable chamber 11 in sequence.

With the above structure, when inflatable roller is inflated, an inflatable device can be configured to align the air inlet 422, at the same time, the one-way valve core assembly 6 opens the second air outlet 421, the gas passes through the air inlet 422, the second air outlet 421, the first air outlet 412 in sequence, and finally enter into the inflatable chamber 11, to inflate the inflatable roller. When the inflatable device is taken away, the one-way valve core assembly 6 closes the second air outlet 421 to ensure a unidirectional flow of the gas, achieving the airtightness and inflation safety of the roller body 10. When the roller needs to be deflated, the second air outlet 421 is opened manually through the one-way valve core assembly 6, the gas is discharged through the second air outlet 421 as well as the air inlet 422, realizing the deflation of the roller.

In this embodiment, the inner wall of the valve body 41 is provided with a third internal thread 413. An outer wall of the inner core 42 is provided with a third external thread 423 for matching and connecting with the third internal thread 413. With the above structure, the inner wall of the valve body 41 is provided with a third internal thread 413, the outer wall of the inner core 42 is provided with a third external thread 423 for matching and connecting with the third internal thread 413, the valve body 41 and the inner core 42 are firmly assembled through a thread connection, ensuring the structural stability and airtightness of the entire assembly.

In this embodiment, the valve body 41 includes a plurality of the first air outlets 412, the plurality of the first air outlets 412 are disposed in a circular array on the valve body 41. Specifically, a width of the first air outlet 412 gradually increases from the inner wall of the valve body 41 toward an outer wall of the valve body 41. With the above structure, the valve body 41 is configured with the plurality of the first air outlets 412 in a circular array, and the width of each the first air outlet 412 gradually increases from the inner wall of the valve body 41 toward the outer wall of the valve body 41, optimizing the airflow channel design, effectively improving the gas flow efficiency during inflation or deflation, and reducing airflow resistance.

In this embodiment, the outer wall of the inner core 42 is concavely provided with a first sealing groove 424, a first sealing ring 4241 is disposed in the first sealing groove 424 to seal a gap between the outer wall of the inner core 42 and the inner wall of the valve body 41. The outer wall of the inner core 42 is concavely provided with a first sealing groove 424, the first sealing ring 4241 is disposed in the first sealing groove 424, to seal the gap between the outer wall of the inner core 42 and the inner wall of the valve body 41, further enhancing the overall airtightness and pressure resistance.

In this embodiment, the first inflatable valve assembly 4 further includes a valve cover 43, the valve cover 43 is configured to open or close the air inlet 422.

Furthermore, the air inlet 422 of the inner core 42 is configured with a clamping rod 425. A bottom of the valve cover 42 is provided with a spiral shape first clamping block 431 and a second clamping block 432, and the first clamping block 431 and the second clamping block 432 are respectively clamped with the clamping rod 425.

Furthermore, a top of the valve cover 43 is provided with a pushing rod 433, the pushing rod 433 includes a first pushing arm 4331 and a second pushing arm 4332 disposed in opposite direction. The top of the inner core 42 is provided with a first stopping block 426 and a second stopping block 427 opposite to each other. When the pushing rod 433 is pushed until the first clamping block 431 and the second clamping block 432 are respectively clamped with the clamping rod 425, the first pushing arm 4331 contacts with the first stopping block 426, and the second pushing arm 4332 contacts with the second stopping block 427.

With the above structure, by configuring the valve cover 43 in the first inflatable valve assembly 4, the valve cover 43 is configured to open or close the air inlet 422, which is convenient for inflating or sealing the roller body 10, improving the convenience and airtightness of use. The bottom of the valve cover 43 is provided with the spiral shape first clamping block 431 and the second clamping block 432, the first clamping block 431 and the second clamping block 432 are respectively clamped with the clamping rod 425 disposed on the air inlet 422 of the inner core 42, by rotating the valve cover 43, achieving quick and reliable connection and locking, and improving the operational efficiency of installation and detachability and the connection stability. Furthermore, the top of the valve cover 43 is provided with a pushing rod 433, the pushing rod 433 includes the first pushing arm 4331 and the pushing arm 4332 disposed in opposite direction. The top of the inner core 42 is configured with the first stopping block 426 and the second stopping block 427. When the pushing is completed, he first stopping block 426 and the second stopping block 427 respectively contact with corresponding stopping block, to ensure that the valve cover 43 is accurately positioned during the rotation and locking process, further improving the convenience of the product.

In this embodiment, the one-way valve core assembly 6 includes a coupling sleeve 61 disposed in a middle of clamping rod 425, a valve rod 62 disposed to ascend and descend in the coupling sleeve 61, a valve plug 63 connected with a bottom end of the valve rod 62 and a spring 64 sleeved on the valve rod 61. A top of the valve rod 62 is connected with a limiting member 65. A top end of the spring 64 contacts with the limiting member 65, a bottom end of the spring 64 contacts with a bottom wall of the coupling sleeve 61. One side close to the inner core 42 of the valve plug 63 is configured with a second sealing ring 631, the second sealing ring 631 is configured to seal a gap between the valve plug 63 and a bottom end of the inner core 42. With the above structure, when the inflatable device is used to inflate, the valve rod 62 is squeezed downward, driving the valve plug 63 downward, thereby opening the second air outlet 421, the gas enters the first air outlet 412 through the second air outlet 421 and enters the inflatable chamber 11. When the inflatable device is taken away, the valve rod 62 rises under the elasticity of the spring 64, to drive the valve plug 63 to contact with the bottom end of the inner core 42, and because the second sealing ring 631 is configured between the valve plug 63 and the inner core 42, thereby ensuring the sealing of the one-way valve core assembly 6. This design effectively realizes the unidirectional flow of gas, prevents backflow, and improves the airtightness and safety of the inflatable chamber 11.

In this embodiment, the limiting member 65 includes a limiting portion 651 and a connection portion 652. The connection portion 652 is provided with a second external thread 6521. A top end of the valve rod 62 is provided with a first mounting groove 621, a second internal thread 6211 is provided in the first mounting groove 61 and matched with the second external thread 6521. With the above structure, the limiting member 65 is installed on a top of the valve rod 62 through thread connection, improving the assembly efficiency, making the limiting member 65 more firmly fixed, avoiding loosening during use, further ensuring the opening and closing reliability and airtightness of the one-way valve core assembly 6.

In this embodiment, the top of the inner core 42 is configured with a third sealing ring 428, the third sealing ring 428 is disposed between the valve cover 43 and the top of the inner core 42. The third sealing ring 428 is configured to seal a gap between the valve cover 43 and the inner core 42. With the above structure, effectively preventing gas leakage from the connection between the valve cover 43 and the inner core 42, further improving the overall airtightness of the inflatable chamber 11, enhancing the stability and pressure resistance of the product in the inflation state, at the same time extending the service life of the roller and improving the safety of use.

In this embodiment, one end close to the third sealing ring 428 of the inner core 42 is provided with a hollow annular groove 429, the hollow annular groove 429 is provided with a plurality of reinforcing ribs 4291, the reinforcing ribs 4291 are disposed in the hollow annular groove 429 with a circular array. With the above structure, reducing the weight of the inner core 42, improving the structural strength and stability.

In this embodiment, a width of the roller body ranges from 1cm to 100cm. A length of the roller body 10 ranges from 1cm to 200cm. With the above structure, the roller body 10 is approximately cylindrical in shape, and a diameter of the roller body 10 ranges from 1cm to 100cm.

As described above, one or more embodiments are provided in conjunction with the detailed description, The specific implementation of the present invention is not confirmed to be limited to that the description is similar to or similar to the method, the structure and the like of the present invention, or a plurality of technical deductions or substitutions are made on the premise of the conception of the present invention to be regarded as the protection of the present invention.

What is claimed is:

1. An inflatable roller, comprising:
a roller body comprising a circumferential sidewall, a first end cap and a second end cap connected with two ends of the circumferential sidewall,
wherein the circumferential sidewall, the first end cap and the second end cap surround and form an inflatable chamber.

2. The inflatable roller according to claim 1, further comprising a first inflatable valve assembly, wherein the first inflatable valve assembly is configured on the roller body, and the first inflatable valve assembly is configured to inflate the roller body.

3. The inflatable roller according to claim 1, wherein the first end cap is connected with the circumferential sidewall by an Voltage heat sealing connection or an adhesive bonding connection or a heat staking connection, and the second end cap is connected with the circumferential sidewall by the Voltage heat sealing connection or the adhesive bonding connection or the heat staking connection.

4. The inflatable roller according to claim 1, wherein the first end cap comprises a first inner end cap and a first outer end cap, the first inner end cap is connected with the circumferential sidewall by the Voltage heat sealing connection or the adhesive bonding connection or the heat staking connection, the first outer end cap is connected with an outer side of the first inner end cap, the first outer end cap is a plastic end cap;
the second end cap comprises a second inner end cap and a second outer end cap, the second inner end cap is connected with the circumferential sidewall by the Voltage heat sealing connection or the adhesive bonding connection or the heat staking connection, the second outer end cap is connected with an outer side of the second inner end cap, and the second outer end cap is the plastic end cap.

5. The inflatable roller according to claim 4, wherein the first outer end cap is connected with the first inner end cap by a first locking assembly,
the first locking assembly comprises a first locking member configured on the outer side of the first inner end cap and a first locking matching member configured on an inner side of the first inner end cap and correspondingly connected with the first locking member,
the first inner end cap comprises a first connection hole, the first locking matching member comprises a first connection groovy matching the first connection hole, the first connection groovy is provided with a first internal thread, the first outer end cap is provided with a first connection column matching the first connection hole, the first connection column is provided with a first external thread matching the first internal thread;
the second outer end cap is connected with the second inner end cap by a second locking assembly, the second locking assembly comprises a second locking member configured on the first inflatable valve assembly and located on an inner side of the second inner end cap and a second locking matching member configured on the second outer end cap,
the second locking member is a second connection groovy configured on the first inflatable valve assembly, and the second locking matching member is a second connection column configured on the second end cap and snapped with the second connection groovy.

6. The inflatable roller according to claim 1, wherein the material of the first end cap and the second end cap is the same as the material of the circumferential sidewall;
the circumferential sidewall is a TPU circumferential sidewall, or a PVC circumferential sidewall, or a PP circumferential sidewall, or a PE circumferential sidewall, or a PE circumferential sidewall, or an EVA circumferential sidewall, or a PA circumferential sidewall, or a PVDF circumferential sidewall, or a PET polyester circumferential sidewall, or a PTFE circumferential sidewall, or an ETFE circumferential sidewall, or a PU imitation leather circumferential sidewall, or a leather circumferential sidewall, or a plastic cement circumferential sidewall.

7. The inflatable roller according to claim 1, wherein the circumferential sidewall is composed of a first sidewall layer and a second sidewall layer in a layered form in an upper and lower direction, the first sidewall layer and the second sidewall layer are sidewall layers made of different materials;
the first sidewall layer is a TPU first sidewall layer, or a PVC first sidewall layer, or a PP first sidewall layer, or a PE first sidewall layer, or an EVA first sidewall layer, or a PA first sidewall layer, or a PVDF first sidewall layer, or a PET polyester first sidewall layer, or a PTFE first sidewall layer, or an ETFE first sidewall layer, or a PU imitation leather first sidewall layer, or a leather first sidewall layer, or plastic cement first sidewall layer;
the second sidewall layer is a mesh fabric, or an Oxford cloth, or a woven cloth.

8. The inflatable roller according to claim 1, wherein the first inflatable valve assembly is disposed on the first end cap or the second end cap.

9. The inflatable roller according to claim 1, wherein the first inflatable valve assembly is disposed on the circumferential sidewall;
the circumferential sidewall is concavely provided with a second mounting groove, the second mounting groove comprises a flat middle portion and inclined portions on both sides, and the first inflatable valve assembly is disposed on the middle portion.

10. The inflatable roller according to claim 1, further comprising a second inflatable valve assembly, wherein the first inflatable valve assembly is disposed on the first end cap, and the second inflatable valve assembly is disposed on the second end cap.

11. The inflatable roller according to claim 1, wherein the roller body comprises a mounting port for installing the first inflatable valve assembly, the first inflatable valve assembly comprises a valve body, an inner core and a one-way valve core assembly;
the valve body is disposed in the inflatable chamber and connected with an inner wall of the roller body, the valve body comprises a mounting cavity and a first air outlet connected with the mounting cavity, the first air outlet is connected with the inflatable chamber;
the inner core is disposed in the mounting cavity and connected to an inner wall of the valve body, a bottom of the inner core comprises a second air outlet for connecting with the first air outlet, a top of the inner core comprises an air inlet connected with the second air outlet;
the one-way valve core assembly is configured to open or close the second air outlet, wherein a gas passes through the air inlet, the second air outlet, the first air outlet and the inflatable chamber in sequence.

12. The inflatable roller according to claim 11, wherein the inner wall of the valve body is provided with a third internal thread, an outer wall of the inner core is provided with a third external thread for matching and connecting with the third internal thread;
the valve body comprises a plurality of the first air outlets, the plurality of the first air outlets are disposed in a circular array on the valve body;
and a width of the first air outlet gradually increases from the inner wall of the valve body toward an outer wall of the valve body.

13. The inflatable roller according to claim 11, wherein the outer wall of the inner core is concavely provided with a first sealing groove, and a first sealing ring is disposed in the first sealing groove to seal a gap between the outer wall of the inner core and the inner wall of the valve body.

14. The inflatable roller according to claim 11, wherein the first inflatable valve assembly further comprises a valve cover, and the valve cover is configured to open or close the air inlet.

15. The inflatable roller according to claim 14, wherein the air inlet of the inner core is configured with a clamping rod, a bottom of the valve cover is provided with a spiral shape first clamping block and a second clamping block, and the first clamping block and the second clamping block are respectively clamped with the clamping rod.

16. The inflatable roller according to claim 15, wherein a top of the valve cover is provided with a pushing rod, the pushing rod comprises a first pushing arm and a second pushing arm disposed in opposite direction;
the top of the inner core is provided with a first stopping block and a second stopping block opposite to each other, when the pushing rod is pushed until the first clamping block and the second clamping block are respectively clamped with the clamping rod, the first pushing arm contacts with the first stopping block, and the second pushing arm contacts with the second stopping block.

17. The inflatable roller according to claim 11, wherein the one-way valve core assembly comprises a coupling sleeve disposed in a middle of clamping rod, a valve rod disposed to ascend and descend in the coupling sleeve, a valve plug connected with a bottom end of the valve rod and a spring sleeved on the valve rod,
a top of the valve rod is connected with a limiting member, a top end of the spring contacts with the limiting member, a bottom end of the spring contacts with a bottom wall of the coupling sleeve, one side close to the inner core of the valve plug is configured with a second sealing ring, and the second sealing ring is configured to seal a gap between the valve plug and the bottom end of the inner core.

18. The inflatable roller according to claim 17, wherein the limiting member comprises a limiting portion and a connection portion, the connection portion is provided with a second external thread, a top end of the valve rod is provided with a first mounting groove, and a second internal thread is provided in the first mounting groove and matched with the second external thread.

19. The inflatable roller according to claim 14, wherein the top of the inner core is configured with a third sealing ring, the third sealing ring is disposed between the valve cover and the top of the inner core, and the third sealing ring is configured to seal a gap between the valve cover and the inner core; one end close to the third sealing ring of the inner core is provided with a hollow annular groove, the hollow annular groove is provided with a plurality of reinforcing ribs, the reinforcing ribs are disposed in the hollow annular groove with a circular array.

20. The inflatable roller according to claim 1, wherein a width of the roller body ranges from 1cm to 100cm; and a length of the roller body ranges from 1cm to 200cm.
